(19) United States
(12) Patent Application Publication
(10) Pub. No.: US 2026/0201934 A1
(43) Pub. Date: Jul. 16, 2026

(54) BRAKING SYSTEM OF A MOTOR VEHICLE DRIVEN BY AN ELECTRIC MACHINE

(71) Applicant: Schaeffler Technologies AG & Co. KG, Herzogenaurach (DE)

(72) Inventors: Doris Maria Wimmer, Ottenhöfen (DE); Simon Ortmann, Pulheim (DE); Benedikt Grubauer, Neresheim (DE); Alan Barrera Bohorquez, Karlsruhe (DE)

(73) Assignee: Schaeffler Technologies AG & Co. KG, Herzogenaurach (DE)

(21) Appl. No.: 19/135,375

(22) PCT Filed: Nov. 10, 2023
(86) PCT No.: PCT/DE2023/100858

§ 371 Date: Jun. 4, 2025

(30) Foreign Application Priority Data
Dec. 7, 2022 (DE) 10 2022 132 495.8

(51) Int. Cl. F16D 65/833; B60T 1/06; F16D 51/00; F16D 65/22; F16D 65/78

(52) U.S. Cl. CPC F16D 65/833; B60T 1/062; F16D 51/00; F16D 65/22; F16D 2065/784

(57) ABSTRACT

A braking system for a motor vehicle includes a brake housing, a drum brake arranged in the brake housing, a brake shoe, a brake actuator and an electric machine. The drum brake has a brake drum and the brake shoe is arranged to apply a friction torque to the brake drum. The brake actuator is arranged to radially displace the brake shoe towards the brake drum to apply the friction torque. The electric machine has a rotor coupled to the brake drum and arranged to be coupled to a wheel of the motor vehicle. The braking system may include a brake cooling circuit arranged for dissipating heat from the drum brake.

### CROSS-REFERENCE TO RELATED APPLICATIONS

This application is the United States National Phase of PCT Appln. No. PCT/DE2023/100858 filed Nov. 10, 2023, which claims priority to German Application No. DE102022132495.8 filed Dec. 7, 2022, the entire disclosures of which are incorporated by reference herein.

### TECHNICAL FIELD

The present disclosure relates to a braking system of a motor vehicle that can be electrically driven by means of an electric machine. The braking system includes a drum brake with a brake drum to which friction torque can be applied by means of at least one brake shoe which can be displaced radially in the direction of the brake drum by a brake actuator, and the electric machine has a rotor which is coupled in a torque-transmitting manner to at least one vehicle wheel of the motor vehicle.

### BACKGROUND

Electric motors are increasingly being used to drive motor vehicles to create alternatives to internal combustion engines that require fossil fuels. Significant efforts have already been made to improve the suitability of electric drives for everyday use and also to be able to offer users the driving comfort which they are accustomed to. A detailed description of an electric drive can be found, for example, in an article in the German automotive magazine ATZ, volume 113, 05/2011, pages 360-365 by Erik Schneider, Frank Fickl, Bernd Cebulski and Jens Liebold with the title: Hochintegrativ und Flexibel Elektrische Antriebseinheit für E-Fahrzeuge [Highly Integrative and Flexible Electric Drive Unit for E-Vehicles]. This article describes a drive unit for an axle of a vehicle, which comprises an electric motor arranged to be coaxial to a bevel gear differential.

Vehicles of this type with a hybridized or electrified drive train can not only accelerate but also brake with the aid of an electric machine. During braking, the electric machine is operated as a generator and the recuperated energy is used to charge the battery, for example. For safety reasons, however, an additional mechanical braking device is still required. For drives in the vicinity of the wheel, such as a wheel hub motor or an electric axle, this results in a more difficult proposition in terms of installation space.

In particular, a vehicle with an electric wheel hub drive, a so-called e-wheel drive, often uses brakes with disks in order to slow down the vehicle. However, disk brakes with floating calipers, disk brakes with fixed calipers, drum brakes and multi-disk brakes are also known.

DE 10 2019 120 409 A1, for example, discloses a braking device for a wheel hub drive assembly in which the braking partners, which are fixed relative to the circumferential direction, have cooling channels. The axially movable braking partner is actuated via brake cylinders. The braking partner which moves in the circumferential direction is designed as a disk carrier.

There is also an increasing requirement to reduce or completely avoid brake wear emissions, which often occur as particulate matter.

### SUMMARY

The present disclosure provides an improved braking system with high braking torques, high operational safety and low brake dust emissions.

A braking system of a motor vehicle that can be electrically driven by means of an electric machine includes a drum brake with a brake drum, to which friction torque can be applied by means of at least one brake shoe which can be displaced radially in the direction of the brake drum by a brake actuator. The electric machine has a rotor which is coupled in a torque-transmitting manner to at least one vehicle wheel of the motor vehicle The drum brake is accommodated in a brake housing and the brake drum is connected to the rotor of the electric machine in a torque-transmitting manner.

The braking system according to the disclosure supplements the recuperation of the electric machine in generator mode in driving situations where this alone cannot provide the desired braking energy. These are, for example, driving situations with a low vehicle speed or low speed of the electric machine or stopping to a standstill or braking at a low temperature.

With an additional, encapsulated brake, the braking energy can be transferred in the form of heat to the vehicle's thermal management system without having to store the energy in the vehicle's battery, for example. In addition, brake dust particles are not released into the environment. If legal regulations allow it in the future, it may also be possible to dispense with the wheel brakes on one axle, for example.

This type of brake is sometimes referred to as a complementary brake.

### Brake housing

The brake may be arranged in a brake housing. The brake housing encloses the brake. A brake housing can also accommodate one or more brake actuators. The brake housing can furthermore be part of a cooling system, and can be designed in such a way that cooling fluid can be supplied to the braking system via the brake housing and/or the heat can be dissipated to the outside via the housing surfaces. The brake housing also protects the complementary brake from external mechanical and/or chemical influences. A brake housing can be formed in particular from a metallic material. The brake housing can be formed from a metallic cast material, such as gray cast iron or cast steel. In principle, it is also conceivable to form the brake housing entirely or partially from a plastic. It is also possible for the brake housing to be designed in one piece or in several parts.

The brake housing can also be designed completely or in part as part of a motor housing of an electric machine or a transmission housing of a transmission coupled to the electric machine. The brake housing and the motor housing or the transmission housing may form a single structural unit. For example, the brake housing can be screwed to the motor housing or the transmission housing. The brake housing may be designed in such a way that wear emissions generated during braking cannot escape from the brake housing. This prevents unwanted pollution of the environment by brake wear emissions. Braking noise can also be reduced by encapsulating the braking system in this way. A further aspect of this encapsulation is that the braking performance of the braking system is independent of the weather conditions outside the vehicle.

### Brake Actuator

In particular, a brake actuator has the function of activating the brake, i.e., setting it to a frictional operating state and an operating state released from the frictional connection. In particular, the brake actuator can be actuated pneumatically, hydraulically, by means of an electric motor, mechanically, electromagnetically or any combination thereof.

### Electric Machine

The braking system according to the disclosure may be provided for a motor vehicle that can be electrically driven by means of an electric machine. For the purposes of this application, electric machines are used to convert electrical energy into mechanical energy and/or vice versa, and generally include a stationary part referred to as a stator or stationary armature, and a part referred to as a rotor or moving armature and arranged movably relative to the stationary part. In connection with the present disclosure, an electric machine can be designed in particular as a rotary machine. With such electric rotary machines, a distinction is made between radial flux machines and axial flux machines. In a radial flux machine, the magnetic field lines extend in the radial direction in the air gap formed between rotor and stator, while in the case of an axial flux machine, the magnetic field lines extend in the axial direction in the air gap formed between rotor and stator.

In connection with the present disclosure, an electric machine is intended in particular for use within a drive train of a hybrid or fully electrically driven motor vehicle. In particular, the electric machine is dimensioned such that vehicle speeds of more than 50 km/h, more than 80 km/h, or more than 100 km/h can be achieved. The electric machine may have an output of more than 30 kW, more than 50 kW, or more than 70 kW. Furthermore, the electric machine may provide speeds greater than 5000 rpm, greater than 10,000 rpm, or greater than 12,500 rpm.

The electric machine can have a housing, also known as a motor housing. The motor housing encloses the electric machine. A motor housing can also accommodate the control and power electronics, and may also at least parts of the braking system. The motor housing can furthermore be part of a cooling system for the electric machine, and can be designed such that cooling fluid can be supplied to the electric machine via the motor housing and/or the heat can be dissipated to the outside via the motor housing surfaces. In addition, the motor housing protects the electric machine and any electronics that may be present from external mechanical and/or chemical influences. A motor housing of the electric machine can be formed in particular from a metallic material. The motor housing can be formed from a metallic cast material, such as gray cast iron or cast steel. In principle, it is also conceivable to form the motor housing entirely or partially from a plastic. It is also possible for the motor housing of the electric machine to be designed in one piece or in several parts.

A rotor is the rotating (spinning) part of an electric machine. The rotor includes a rotor shaft and one or more rotor bodies formed of rotor lamination stacks which are arranged on the rotor shaft in a non-rotatable manner. The rotor shaft can be hollow, which on the one hand results in weight savings and on the other hand allows the supply of lubricant or coolant to the rotor body. In particular, the rotor shaft can be coupled to the brake shaft of the complementary brake.

### Transmission

The electric machine and/or the brake can be coupled to a transmission, which is designed in particular to generate a drive torque for the motor vehicle. The drive torque may be a main drive torque, such that the motor vehicle is driven exclusively by the drive torque.

Provision can in particular be made for the electric machine and/or the brake as well as the transmission to be arranged in a common drive train housing. Alternatively, it would of course also be possible for the electric machine to have a motor housing and the transmission to have a transmission housing, and the structural unit can then be brought about by fixing the transmission arrangement in relation to the electric machine. This structural unit is sometimes also referred to as an e-axle. The drive train housing may be formed from a metallic material, e.g., from aluminum, gray cast iron or cast steel, in particular by means of a primary shaping process such as casting or die-casting. In principle, however, it would also be possible to form the drive train housing from a plastic material. The drive train housing may have a cup-like basic shape, such that the electric machine and the transmission can be inserted into the drive train housing via the open end face thereof.

The electric machine may have a motor housing and/or the transmission may have a transmission housing, and the structural unit can then be implemented by fixing the transmission in relation to the electric machine. The transmission housing is a housing for accommodating a transmission. It has the task of guiding existing shafts via the bearings and giving the wheels (cam disks, where applicable) the degrees of freedom they require under all loads without impeding their rotational and possible path movement, as well as absorbing bearing forces and supporting torques. A transmission housing can be designed as single-shell or multi-shell, i.e., undivided or divided. In particular, the transmission housing should be able to dampen noise and vibrations as well as safely absorb hydraulic fluid. The transmission housing may be formed from a metallic material, e.g., from aluminum, gray cast iron or cast steel, in particular by means of a primary shaping process such as casting or die-casting.

Furthermore, the transmission can be configured as a planetary transmission or include a planetary transmission. The planetary transmission can have a sun gear and a plurality of planet gears meshing with the sun gear and rotatably mounted in a planet gear carrier, which rotate around the sun gear, as well as a ring gear arranged coaxially to the sun gear, in which the planet gears roll.

The transmission can also have a differential gear. A differential gear mechanism is a planetary transmission with one drive and two outputs. It usually has the function of driving two vehicle wheels of a motor vehicle in such a way that they can turn at different speeds when cornering, but with the same propulsive force.

### Separating Clutch

In order to implement different driving or operating modes for the vehicle, one or more separating clutches can be provided within the torque path between the electric machine and a vehicle wheel. A separating clutch can be arranged between the output of the electric machine and the input of the transmission, for example, so that the electric machine can be decoupled from the transmission, allowing the vehicle to be operated in coasting mode. It would also be conceivable to arrange a separating clutch between the output of the transmission and a vehicle wheel or the vehicle wheels, which would also make it possible to implement a coasting operation of the motor vehicle. Finally, it is also possible to arrange a separating clutch between the input of the braking system and the output of the electric machine, which allows the braking system to be completely decoupled from the electric machine.

### Motor Vehicle

For the purposes of this application, motor vehicles are land vehicles that are moved by machine power without being bound to railroad tracks. A motor vehicle can be selected, for example, from the group of passenger cars, trucks, small motorcycles, light motor vehicles, motorcycles, motor buses/coaches or tractors.

### Example Embodiments

Example embodiments are described herein. The features listed individually can be combined with one another in a technologically meaningful manner and can define further embodiments. In addition, the features indicated are specified and explained in more detail in the description, wherein further embodiments are shown.

According to an example embodiment, it can be provided that the braking system has a brake cooling circuit for dissipating heat from the drum brake. With this design, the heat generated by the frictional energy of the brake can be dissipated and made available to a thermal management system of a motor vehicle, for example. Furthermore, cooling the brake can increase its braking performance and, in particular, reduce thermal fading, i.e., heat-related loss of braking force.

### Thermal Management System

In the context of the present disclosure, the term thermal management refers to the demand-oriented and efficient control of thermal energy flows in an electrically powered vehicle, in particular a battery-powered vehicle, according to the prevailing operating or load condition.

The vehicle's thermal management system can include a hydraulic control system. A hydraulic control system directs the volume flows within a thermal management system of a motor vehicle by means of switching elements that hydraulically act on a fluid, such as valves, slides, pumps and the like. The hydraulic control system can, for example, completely or partially throttle a volume flow and/or distribute it to the relevant heat sources and sinks in sub-circuits of the thermal management system of a motor vehicle. For this purpose, the hydraulic switching elements are controlled and switched by the electronic control unit.

A hydraulic switching element can be a hydraulic pump, a switching valve, a controllable throttle valve and the like. A hydraulic switching element can be electrically controlled. Furthermore, a hydraulic switching element may have at least two different switchable operating states in which the hydraulic switching element acts in different ways on the corresponding fluid in a circuit.

According to an example embodiment, it can therefore be provided that the brake has a brake cooling circuit for dissipating or supplying heat from or to the brake, and the hydraulic control unit acts on the brake cooling circuit by means of at least one hydraulic switching element to influence the volume flows in the brake cooling circuit.

According to an example embodiment, it can be provided that the electric machine has a motor cooling circuit for dissipating or supplying heat from or to the electric machine, and the hydraulic control unit acts on the motor cooling circuit by means of at least one hydraulic switching element to influence the volume flows in the motor cooling circuit.

According to an example embodiment, it can be provided that the thermal management system also includes an inverter with an inverter cooling circuit for dissipating or supplying heat from or to the inverter, and the hydraulic control unit acts on the inverter cooling circuit by means of at least one hydraulic switching element to influence the volume flows in the inverter cooling circuit.

According to an example embodiment, it can be provided that the vehicle battery has a battery cooling circuit for dissipating or supplying heat from or to the vehicle battery, and the hydraulic control unit acts on the battery cooling circuit by means of at least one hydraulic switching element to influence the volume flows in the battery cooling circuit.

According to a further development, it may also be provided that at least one first cooling channel, which can be connected to the brake cooling circuit, is formed in or on the brake drum, whereby heat can be dissipated from the brake drum. An embodiment can also be designed in such a way that the first cooling channel runs in the region of the friction surface of the brake drum with the brake shoe, which further improves heat dissipation from the region subject to a particular degree of thermal stress.

Furthermore, according to an example embodiment, it may be provided that at least one second cooling channel, which can be connected to the brake cooling circuit, is formed in or on the brake housing, whereby the cooling effect can be further improved.

According to a further embodiment, it may be provided that a hydraulic transition region is formed between the first cooling channel of the brake drum and the second cooling channel of the brake housing, via which a cooling fluid can flow from the first cooling channel into the second cooling channel and vice versa. This has the particular effect that the brake cooling circuit can be routed from the brake drum to the brake housing, i.e., from a component that rotates during operation to a stationary component.

Furthermore, the disclosure can also be further developed in such a way that the transition region is designed as an annular disk-like gap, which is sealed radially on the inside by a first sealing element and radially on the outside by a second sealing element, whereby a transition region can be provided which is particularly favorable in terms of flow.

In an example embodiment, it can also be provided that the first cooling channel in the region of the gap is designed as an annular section-like or ring-shaped groove which is open towards the gap. This allows a further improved hydraulic transition to be realized.

The second cooling channel may be formed in the region of the gap as an annular section-like or ring-shaped groove that is open towards the gap, which further improves the hydraulic transition between the brake drum and the brake housing.

According to a further embodiment, the first sealing element and/or the second sealing element is designed as a labyrinth seal.

This can provide a particularly low-friction and essentially wear-free seal for the gap.

The brake may be configured as a dry-running brake. The braking system may be designed as a “dry” braking system that has cooling channels or cooling hoses in one of the brake components—e.g., in the non-rotating component. Via these channels or hoses, coolant, for example a water-glycol mixture or a cooling oil, is transported to the vehicle's thermal management system. Compared to a “wet” (multi-disk) braking system, a “dry” braking system generates fewer losses when not actuated and the coefficient of friction and therefore the braking torque is more constant.

### BRIEF DESCRIPTION OF THE DRAWINGS

The present disclosure is explained in more detail below with reference to figures without limiting the general concept of the disclosure.

In the figures:

FIG. 1 shows a motor vehicle that can be electrically driven having a braking system in a schematic block diagram view,

FIG. 2 shows an axle drive train of a motor vehicle having a braking system in a schematic axial sectional view,

FIG. 3 shows a drum brake in a schematic axial sectional view, and

FIG. 4 shows a detailed view of the gap of the drum brake in an axial sectional view.

### DETAILED DESCRIPTION

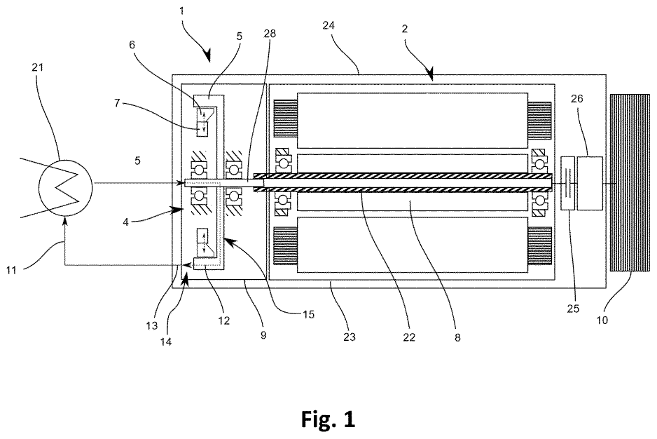

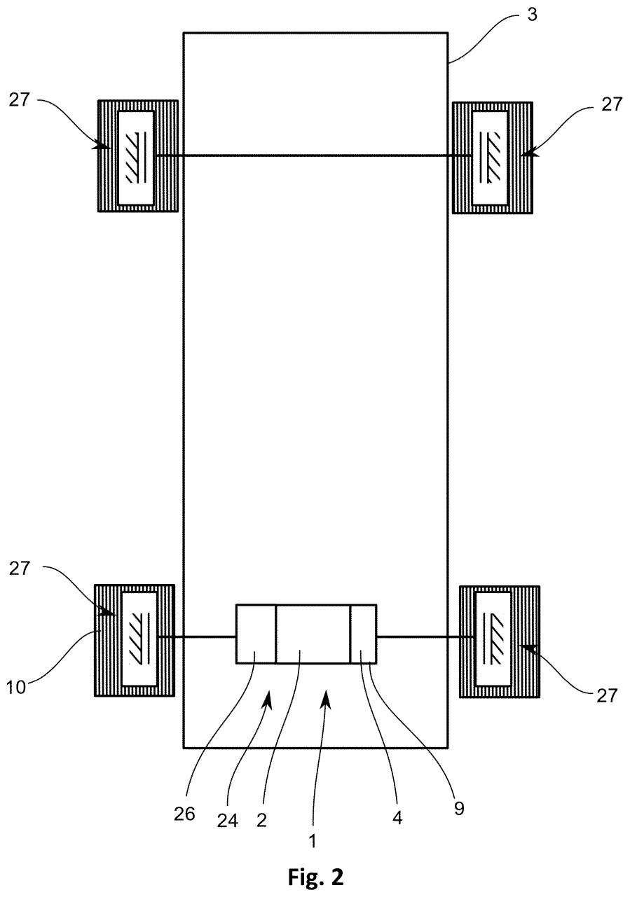

FIG. 1 shows a braking system 1 of a motor vehicle 3 that can be electrically driven by means of an electric machine 2, as illustrated by way of example in FIG. 2. In the embodiment shown in FIG. 2, the braking system 1 also has a service brake system 27 for applying a wheel-selective braking torque to the vehicle wheels 10 of the first vehicle axle and the second vehicle axle.

The braking system 1 also includes a drum brake 4 with a brake drum 5, to which friction torque can be applied by means of at least one brake shoe 6 which can be displaced radially in the direction of the brake drum 5 by a brake actuator 7. The electric machine 2 accommodated in the motor housing 23 has a rotor 8, which is coupled in a torque-transmitting manner to at least one vehicle wheel 10 of the motor vehicle 3.

The drum brake 4 is accommodated in a brake housing 9 and the brake drum 5 is connected to the rotor 8 of the electric machine 2 in a torque-transmitting manner via the brake shaft 28 and the rotor shaft 22. In this configuration, three different deceleration torques can therefore act on one or more of the vehicle wheels 10: the deceleration torque generated by the drum brake 4, the deceleration torque generated by the electric machine 2 and/or the deceleration torque generated by the service brake system 27. Depending on the driving situation and deceleration requirements, these three available deceleration torques can be combined and applied in a controlled manner.

The electric machine 2, the transmission 26 and the drum brake 4 form a structural unit, which is also referred to as the axle drive train 24. A separating clutch 25 is arranged between the electric machine 2 and the vehicle wheel 10, via which the electric machine 2 can be decoupled from the torque path so that, for example, the axle drive train 24 can be set to a coasting mode.

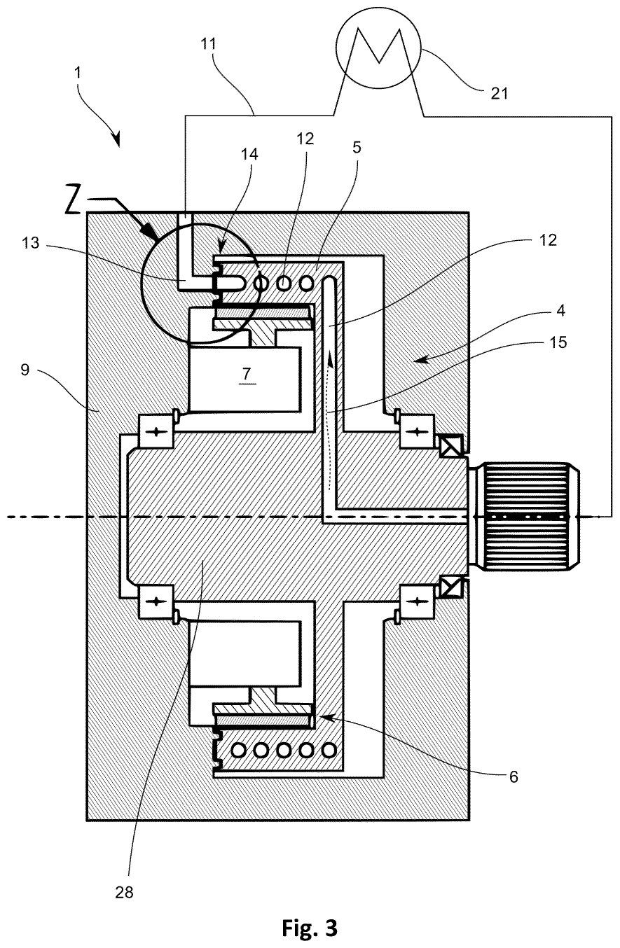

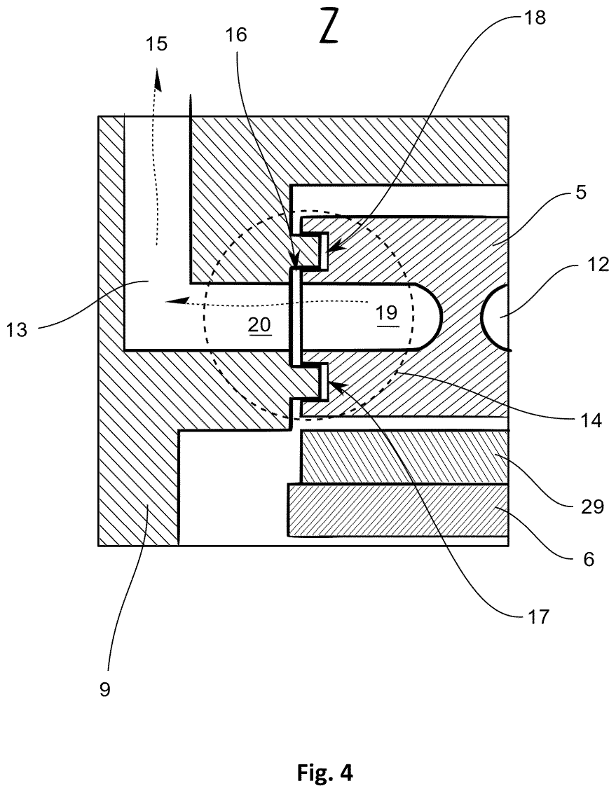

The braking system 1 also has a brake cooling circuit 11 in order to dissipate heat from the drum brake 4. A heat exchanger 21 is arranged in the brake cooling circuit 11, by means of which the heat dissipated from the drum brake 4 can be transferred to a thermal management system of the motor vehicle 3. At least one first cooling channel 12, which can be connected to the brake cooling circuit 11, is formed in or on the brake drum 5. As can be clearly seen in FIG. 3, this runs in the region of the friction surface of the brake drum 5 with the brake shoe 6. Furthermore, at least one second cooling channel 13, which can be connected to the brake cooling circuit 11, is formed in or on the brake housing 9. A hydraulic transition region 14 is formed between the first cooling channel 12 of the brake drum 5 and the second cooling channel 13 of the brake housing 9, via which a cooling fluid 15 can flow from the first cooling channel 12 into the second cooling channel 13 and vice versa. This is explained in more detail below with reference to FIG. 4.

In the embodiment shown, the transition region 14 is designed as an annular disk-like gap 16, which is sealed radially on the inside by a first sealing element 17 and radially on the outside by a second sealing element 18. The first sealing element 17 and the second sealing element 18 are designed as a non-contact labyrinth seal. The first cooling channel 12 is formed in the region of the gap 16 as an annular section-like or ring-shaped groove 19, which is open towards the gap 16. Similarly, the second cooling channel 13 in the region of the gap 16 is also designed as an annular section-like or ring-shaped groove 20, which is open towards the gap 16.

To improve the friction between the brake shoe 6 and the brake drum 5, a friction lining 29 is applied to the radially outer lateral surface of the brake shoe. It would of course also be possible to alternatively or additionally provide the radially inner lateral surface of the brake drum 5 with a friction lining.

The disclosure is not limited to the embodiments shown in the figures. The above description is therefore not to be regarded as limiting, but rather as illustrative. The following claims are to be understood as meaning that a stated feature is present in at least one embodiment of the invention. This does not exclude the presence of further features. Where the claims and the above description define “first” and “second” features, this designation serves to distinguish between two features of the same type without defining an order of precedence.

### REFERENCE NUMERALS

1 Braking system
2 Electric machine
3 Motor vehicle
4 Drum brake
5 Brake drum
6 Brake shoe
7 Brake actuator
8 Rotor
9 Brake housing
10 Vehicle wheel
11 Brake cooling circuit
12 Cooling channel
13 Cooling channel
14 Transition region
15 Cooling fluid
16 Gap
17 Sealing element
18 Sealing element
19 Groove
20 Groove
21 Heat exchanger
22 Rotor shaft
23 Motor housing
24 Axle drive train
25 Separating clutch
26 Transmission
27 Service brake system
28 Brake shaft
29 Friction lining

1. A braking system of a motor vehicle which can be electrically driven by means of an electric machine, wherein the braking system comprises a drum brake with a brake drum, to which friction torque can be applied by means of at least one brake shoe which can be displaced radially in the direction of the brake drum by a brake actuator, and the electric machine has a rotor which is coupled in a torque-transmitting manner to at least one vehicle wheel of the motor vehicle,
wherein:
the drum brake is accommodated in a brake housing and the brake drum is connected to the rotor of the electric machine in a torque-transmitting manner.

2. The braking system according to claim 1, wherein:
the braking system has a brake cooling circuit for dissipating heat from the drum brake.

3. The braking system according to claim 2, wherein:
at least one first cooling channel, which can be connected to the brake cooling circuit, is formed in or on the brake drum.

4. The braking system according to claim 3,
wherein:
at least one second cooling channel, which can be connected to the brake cooling circuit, is formed in or on the brake housing.

5. The braking system according to claim 4, wherein:
a hydraulic transition region is formed between the first cooling channel of the brake drum and the second cooling channel of the brake housing, via which a cooling fluid can flow from the first cooling channel into the second cooling channel and vice versa.

6. The braking system according to claim 5, wherein:
the transition region is formed as an annular disk-like gap, which is sealed radially on the inside by a first sealing element and radially on the outside by a second sealing element.

7. The braking system according to claim 6,
wherein:
the first cooling channel is formed in the region of the gap as an annular section-like or ring-shaped groove which is open towards the gap.

8. The braking system according to claim 6,
wherein:
the second cooling channel is formed in the region of the gap as an annular section-like or ring-shaped groove which is open towards the gap.

9. The braking system according to claim 6,
wherein:
the first sealing element or the second sealing element is designed as a labyrinth seal.

10. The braking system according to claim 3,
wherein:
the first cooling channel runs in the region of the friction surface of the brake drum with the brake shoe.

11. A braking system for a motor vehicle, comprising:
a brake housing;
a drum brake arranged in the brake housing and comprising a brake drum;
a brake shoe arranged to apply a friction torque to the brake drum;
a brake actuator arranged to radially displace the brake shoe towards the brake drum to apply the friction torque; and
an electric machine comprising a rotor coupled to the brake drum and arranged to be coupled to a wheel of the motor vehicle.

12. The braking system of claim 11 further comprising a brake cooling circuit arranged for dissipating heat from the drum brake.

13. The braking system of claim 12 further comprising a first cooling channel formed in or on the brake drum and arranged to be connected to the brake cooling circuit.

14. The braking system of claim 13, wherein the first cooling channel is arranged in a friction surface of the brake drum proximate the brake shoe.

15. The braking system of claim 13 further comprising a second cooling channel formed in or on the brake housing and arranged to be connected to the brake cooling circuit.

16. The braking system of claim 15 further comprising a hydraulic transition region arranged to permit a flow of cooling fluid between the first cooling channel and the second cooling channel.

17. The braking system of claim 16 further comprising:
a first sealing element arranged for sealing a radial inside of the hydraulic transition region; and
a second sealing element arranged for sealing a radial outside of the hydraulic transition region, wherein the hydraulic transition region formed as an annular disk-like gap.

18. The braking system of claim 17, wherein the first cooling channel is an annular section-like or ring-shaped groove open towards the annular disk-like gap.

19. The braking system of claim 17, wherein the second cooling channel is an annular section-like or ring-shaped groove open toward the annular disk-like gap.

20. The braking system of claim 17, wherein the first sealing element or the second sealing element is a labyrinth seal.
